(19) United States
(12) Patent Application Publication
(10) Pub. No.: US 2020/0031694 A1
(43) Pub. Date: Jan. 30, 2020

(54) GROUNDWATER TREATMENT SYSTEMS AND METHODS

(71) Applicant: ELLINGSON DRAINAGE, INC., WEST CONCORD, MN (US)

(72) Inventors: Michael D. LUBRECHT, Monroe, WA (US); James DITTO, Julian, PA (US); Daniel W. OMBALSKI, Weatherford, TX (US)

(21) Appl. No.: 16/522,276

(22) Filed: Jul. 25, 2019

Related U.S. Application Data
(60) Provisional application No. 62/703,336, filed on Jul. 25, 2018.

(51) Int. Cl. C02F 1/70

(52) U.S. Cl. CPC C02F 1/70; C02F 2103/06

(57) ABSTRACT

Groundwater treatment systems and methods that include a filter or media cartridge that can be interconnected with one or more other media cartridges to form a series of media cartridges. The media cartridge includes media retained therein that treat and/or filters groundwater as it permeates through the media. The media can include reactive media to assist with treating the groundwater. Additionally, the media cartridge includes a baffle positioned within the media and contacting an inner surface of the media cartridge to prevent the formation of channels within the media. An external seal can be positioned about the exterior of the media cartridge to prevent groundwater from bypassing the media cartridge.

### CROSS-REFERENCE TO RELATED APPLICATIONS

This patent application claims the benefit of and priority to U.S. Provisional Patent Application Ser. No. 62/703,336, filed on Jul. 25, 2018, entitled “GROUNDWATER TREATMENT SYSTEMS AND METHODS,” the contents of which are hereby incorporated by reference in their entirety.

### BACKGROUND

Groundwater contamination can be caused by a variety of sources, many related to human activities. Such contamination can present an environmental and/or health hazard and often requires remediation to treat. Remediation techniques can include injecting treatment compounds/chemicals into the contaminated groundwater or the construction of filtering trenches or permeable barrier walls. The injection of treatment compounds into the contaminated groundwater can be an inefficient process as the introduction of the treatment compounds may be required to occur over a large area and the treatment compounds can be slow to permeate through and treat the contamination. Filtering trenches or permeable barrier walls require the excavation of large amounts of contaminated ground material and the filling of the trenches with large amounts of filtering media, which can be expensive and highly disruptive of project sites and the environment. There exists a need for more efficient and/or cost effective in-situ contaminated groundwater treatment systems and/or methods.

### BRIEF DESCRIPTION OF THE DRAWINGS

FIG. 1 illustrates an example groundwater treatment system.

FIG. 2 illustrates an example filter cartridge system.

FIG. 3 illustrates an example filter cartridge.

FIG. 4 is a block diagram of an example media cartridge.

FIG. 5 illustrates an example flanged end assembly of a media cartridge.

FIG. 6 illustrates an example threaded end assembly of a media cartridge.

FIG. 7 illustrates an example intake end assembly of a media cartridge.

FIGS. 8A-8B illustrate example baffles of a media cartridge.

### DETAILED DESCRIPTION

Groundwater treatment systems and methods are described herein. Example groundwater treatment systems can include a series of connected filter cartridges that can be placed within a horizontal or nearly horizontal well. Contaminated groundwater can flow into the well and through the filter cartridges contained therein to filter and/or treat one or more contaminants of the contaminated groundwater. The filter cartridges can contain filter media that can include a filter material, such as a reactive filter material, and a filler material. Contaminated groundwater can flow, or permeate, through the filter media to be filtered and/or treated.

The filter cartridges can be constructed outside of the well, such as on-site or at another location. The individual construction of filter cartridges can allow for various inspections and/or checks of the filter cartridge prior to installation of the filter cartridge within the well. Additionally, the filter cartridge can be constructed under controlled environments which can assist with efficient construction of the filter cartridge and assist with maintaining a desired, or expected, efficacy of the filter cartridge in filtering and/or treating contaminants within contaminated groundwater.

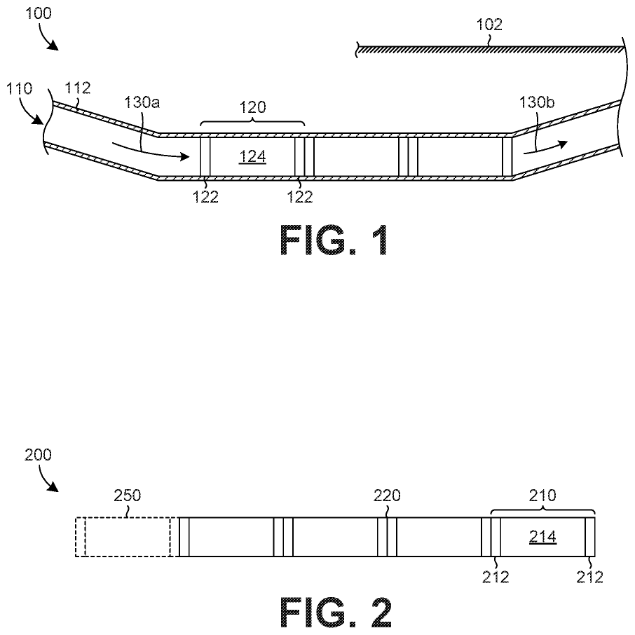

FIG. 1 shows an example groundwater treatment system 100 that includes a well 110 that extends through at least a portion of ground 102. The ground 102 contains groundwater which can be contaminated with one or more pollutants and/or by one or more sources. The groundwater can flow, and/or be forced, through the well 110 which contains filter cartridges 120 that filter at least a portion of the groundwater as it moves through the filter cartridges 120.

The well 110 can be formed using a drilling machine, such a directional drilling machine. In the example shown in FIG. 1, the well 110 has a horizontal profile, however, other profiles and/or directionality of the well 110 can be used. In the example of directional drilling, the well can be guided to have a desired profile and/or pathway through the ground 102. The well 110 can be aligned substantially parallel to, or along, the flow of the groundwater through the ground 102. In this manner, the contaminated groundwater can flow, be directed, or guided into the well 110 for treatment and/or filtering.

Multiple wells 110 can be drilled across the area containing contaminated groundwater to assist with treating and/or filtering of the groundwater. These wells 110 can be spaced apart and can include one or more filter cartridges 120 placed therein to filter, or treat, a contaminant(s) of the contaminated groundwater. As contaminated groundwater can be spread across a large area, the use of multiple wells 110 can assist with the efficiency and/or efficacy of filtering/treatment of the contaminated groundwater.

The well 110 is lined with a casing, or liner, 112. The casing 112 can be constructed of a rigid material, such as a plastic or metal and can be installed within the well 110. The casing 112 material can be selected based on one or more factors, such as economic and/or design factors, such as the cost of the material and/or the reactivity of the material with the surrounding environment.

Filter cartridges 120 can be inserted within the cased well 110 and can be connected in series to provide a conduit of filter cartridge 120 through which the groundwater will flow or permeate. The filter cartridges 120 can be pushed into the well, such as through the use of the well 110 drilling machine. A fixture can be attached to the well drilling machine to assist with engaging the filter cartridges 120 for placement within the well 110.

The filter cartridges 120 can include a main body 124 with end caps 122 at either end. The main body 124 can contain a filter media through which the groundwater will flow or permeate and the end caps 122 can assist with retaining the filter media within the main body 124. The end caps 122 can be affixed and/or sealed to the main body 124 of the filter cartridge 120 and can be permeable to allow groundwater to enter the filter cartridge 120 and/or flow between one or more filter cartridges 120.

The filter media of the filter cartridge 120 can include a filter material and/or a filler material and can be packed within the main body 124 of the filter cartridge 120. The filter material can be a reactive filter material, such as zero valent iron, that can react with contaminant(s). Reaction of the contaminant(s) and the filter material can render the contaminant(s) to another, less polluting state, such as by chemical reduction of the contaminant(s) and/or the formation of less polluting compounds. The filter material can also be a material with which the contaminant(s) will bond and be trapped within the filter media. The filler material can be mixed with the filter material to assist with distributing the filter material throughout the filter media mixture. The filler material can be selected based on one or more factors, such as a reactivity of the filler material and the contaminant(s). In an example, the filler material can be selected to have a low reactivity with the contaminant(s).

The filter cartridges 120 can be prepared and/or constructed at the site of the well 110 or at another location. The modular nature of the filter cartridge 120 can allow each cartridge to be individually prepared and/or inspected prior to installation or use. Additionally, the modular nature can assist with the handling and/or manipulation of the filter cartridges 120, such as during preparation, transport and/or installation.

An end cap 122 of a first filter cartridge 120 can be sealed to the end cap of a second filter cartridge to create a series of connected filter cartridges 120. To seal the filter cartridges together, the end caps can be fused by heat, a mechanical connection, and/or an adhesive to create a watertight seal between the two filter cartridges 120. The connection of one or more filter cartridges 120 can be done during, or prior to, the installation of the filter cartridges 120 within the well 110.

Once in place within the well 110, the connected series of filter cartridges 120 can receive contaminated groundwater 130a at a first end of the series. The contaminated groundwater 130a can flow, or permeate, into and through the series of connected filter cartridges 120 to be filtered. The filtered groundwater 130b can be discharged from a second end of the series of connected filter cartridges 120. The flow of contaminated groundwater 130a into the series of connected filter cartridges 120 can be unassisted and/or can be assisted by pumping, or other means, to assist with moving contaminated groundwater 130a into and/or through the series of connected filter cartridges 120.

The filter cartridges 120 can include an exterior seal between the exterior of the filter cartridges 120 and the interior surface of the casing 112 to prevent the flow of contaminated groundwater 130a around the filter cartridges 120. The filter cartridges 120 can be sized to fit snugly within the casing 112 of the well 110, however, a gap between the exterior of the filter cartridge 120 and the interior surface of the casing 112 can be present and/or can form over time after installation of the filter cartridges 120. To prevent the potential flow of contaminated groundwater 130a through this gap, a seal can be included on one or more of the filter cartridges and/or formed between the exterior of one or more filter cartridges and the interior surface of the casing 112. This seal can prevent the flow of contaminated groundwater 130a about the exterior of the series of filter cartridges 120. In an example, one or more o-rings can be installed about the exterior of the filter cartridge(s) 120 to provide such as seal. In another embodiment, a sealing material, such as expanding foam or bentonite clay, can be placed between the exterior of one or more filter cartridges 120 and the interior surface of the casing 112 to form a seal.

To form the groundwater treatment system 100 of FIG. 1, the well 110 can first be drilled, such as by a directional drilling method and/or machine. As, or once, the well 110 has been drilled, the well 110 can be lined with the casing 112. The filter cartridges 120 can then be inserted and/or placed within the well 110. To assist with placing the filter cartridges 120, the drilling machine can be used to push, or slide, the filter cartridges 120 in the well 110. A fixture can be placed on the drilling machine to interface with the filter cartridge 120 and to assist with preventing damage to the filter cartridge 120, such as due to the force exerted on the filter cartridge 120 by the drilling machine during insertion. A series of filter cartridges 120 can be inserted within the well 110 and the filter cartridges can be connected in series with watertight connections, such as by fusing, bonding, welding, bolting, or otherwise connecting, the series of filter cartridges 120 together. Optionally, a filter cartridge containing a sensor, such as a point velocity probe, can be included in the series of filter cartridges 120 to assist with monitoring the flow of the groundwater through the series of filter cartridges. Once the filter cartridges are in place, contaminated groundwater can be allowed to flow, or permeate, through the series of filter cartridges and/or the flow can be assisted, such as by the use of pumps.

Similarly, to remove the series of filter cartridges 120, the drilling, or other, machine/device can be used to push the filter cartridges 120 through the well 110 and out an end. Alternatively, the drilling machine can extend a tool to engage a mating fixture at the end of the endmost filter cartridge 120 to lock onto and pull the filter cartridges 120 from the well 110. Removal of the filter cartridges 120 can be done to replace one or more filter cartridges 120, or series of filter cartridges 120, to permanently remove the series of filter cartridges 120 when remediation is complete, and/or for various other reasons/purposes. Once removed, the filter cartridges 120, and/or the filter media contained therein, can be processed and/or treated prior to disposal, if needed.

FIG. 2 shows an example filter cartridge system 200, such as can be installed within a well for filtering/treatment of contaminated groundwater. The filter cartridge system 200 can include a series of connected filter cartridges 210. The connection 220 between two filter cartridges 210 can be substantially watertight to assist with minimizing leaking of fluid, such as contaminated groundwater, from the series of connected filter cartridges 210. The connection 220 can be a fused, welded, bonded, threaded, bolted, and/or other connection to connect filter cartridges 210 together. In the example shown in FIG. 2, the end cap 212 of a filter cartridge 210 is bonded/fused to an end cap of another filter cartridge to connect the two filter cartridges together. Alternatively, the filter cartridge 210 can consist of a main body only and a series of filter cartridges can be connected together by bonding/fusing the main body of a first and second filter cartridge 210 to each other. In another embodiment, the filter cartridge end caps may be connected by mating bolted flanges.

The filter cartridge 210 can include a main body 214 and end caps 212. The main body 214 can contain a filter media for filtering or treating one or more contaminants within contaminated groundwater that will flow, or permeate, through the filter cartridge 210. The end caps 212 can be, or can include, permeable membranes that assist with retaining filter media within the main body 214, while allowing fluid, such as groundwater, to flow or permeate through the end caps 212.

A sensor containing filter cartridge 250 can be optionally included in the series of connected filter cartridges 210. The sensor containing filter cartridge 250 can include a sensor, device and/or system to monitor one or more parameters of the filter cartridge system 200, such as performance parameters. In an example, the sensor containing filter cartridge 250 can include a point velocity probe to monitor the flow of groundwater through the series of connected filter cartridges. Data from the sensor within the sensor containing filter cartridge 250 can be relayed to a device/system above ground, such as via a wired and/or a wireless connection, to allow for monitoring of performance and/or efficacy of the series of connected filter cartridges and/or their filtering/treatment of contaminated groundwater.

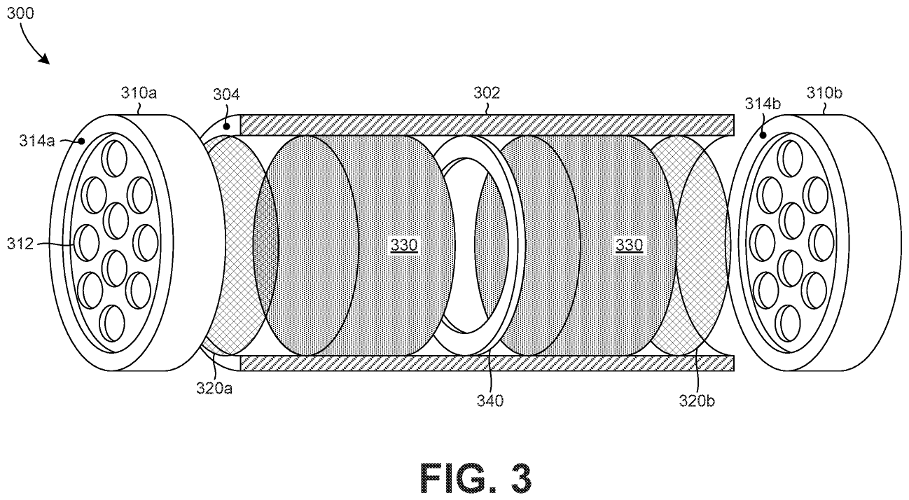

FIG. 3 shows an example filter cartridge 300 that can include a main body 302, end caps 310a, 310b, retaining membranes 320a, 320b, filter media 330, and/or a baffle 340. The end caps 310a, 310b and/or retaining membranes 320a, 320b can assist with retaining the filter media 330 within the main body 302. The end caps 310a, 310b include openings 312 arranged thereon to allow water to flow through the filter cartridge 300 and the filter media 330 contained inside. As the water flows, or permeates, through the filter media 330, pollutants, or contamination, within the water is filtered out by the filter media 330.

The main body 302 of the filter cartridge 300 has a cross-section, such as the circular cross-section shown in FIG. 3, and a length. The cross-section of the main body 302 can be sized and/or profiled to be substantially similar to an inner size and/or profile of the well, or bore, in which the filter cartridge 300 is to be placed. Having substantially similar cross-sections can allow the main body 302 of the filter cartridge 300 to substantially span the interior cross-section of the well, which can minimize, prevent or reduce, the flow of water between the interior of the well and the exterior of the main body 302 of the filter cartridge 300. Water that flows around the exterior of the filter cartridge 300 is not filtered as it does not flow through the filter media 330 of the filter cartridge 300. Material, such as an expanding foam and/or other space filler, can be placed between the exterior of the filter cartridge 300 and the interior surface of the well to assist with preventing and/or minimizing water flow that flows around, or bypasses, the filter cartridge 300.

The length of the main body 302 and/or filter cartridge 300 can be based on one or more factors. In an embodiment, the length of the filter cartridge 300 can be based on the volume and/or weight of the filter media contained, or to be contained, therein. In this manner, the weight and/or size of the filter cartridge 300 can be determined such that the filter cartridge 300 is manageable, such as manually and/or with the use of one or more devices and/or systems. That is, the filter cartridge 300 is sized such that the overall dimensions and/or weight of the filter cartridge 300 are such that the filter cartridge 300 can be manually manipulated, such as carried and/or placed, and/or manipulated with the aid of one or more devices and/or systems. For example, for a filter cartridge 300 having a heavy, and/or a high packing density, filter media 330, the filter cartridge 300 can be sized such that the amount of filter media 330 contained within the filter cartridge 300 is a desired weight and/or within a desired weight range. In another example, a light, and/or low packing density, filter media 330 can be contained within the filter cartridge 300. The filter cartridge 300 can be sized based on a desired weight, or weight range, and/or desired size, or size range, of the filter cartridge 300.

The main body 302 of the filter cartridge can be constructed of one or more materials, such as plastics, composites, metals, and/or combinations thereof. The material of the main body 302 can be selected based on a variety of factors, such as economic factors, environmental factors, design factors and/or other factors/considerations. Economic factors can include expense related factors, such as the cost of materials, the cost for processing/handling the materials, the costs for handling the filter cartridge 300 and/or other associated costs of the filter cartridge 300, its production, use and/or components thereof. Environmental factors can include factors regarding the environment in which the filter cartridge 300 will be placed and/or other environmental factors/considerations. For example, a material selected to construct the main body 302 can be selected based on external forces the filter cartridge 300 will, or is expected to, be subjected to, the reactivity of the material 302 with the environment in which the filter cartridge 300 will be placed and/or other environmental factors/considerations. Design factors can include various factors/considerations regarding the completed filter cartridge 300 and/or its manufacture, such as a size of the filter cartridge 300, the transportation and/or handling of the filter cartridge 300 and/or other design factors/considerations.

The end caps 310a, 310b can be connected, affixed and/or attached to the ends of the main body 302. The connection/interface between the end caps 310a, 310b and the main body 302 can be a watertight connection to prevent contaminated water from flowing out of the series of connected filter cartridge 300. Various connections/interfaces can be used to connect the end caps 310a, 310b to the main body 302, such as welding, bonding, mechanical connections and/or other connections/interfaces. In the example shown in FIG. 3 a surface of the end cap 310a can be connected to the surface 304 of the main body 302. The end cap 310 and the main body can be connected using an adhesive, heat/solvent welding and/or other connection means. Similar, or other, connection means can be used to bond an end cap of a filter cartridge 300 to the end cap of another filter cartridge 300 to form the series of connected filter cartridges 300.

The end caps 310a, 310b include openings 312 to allow the flow of water through the end cap and into the filter cartridge 300. While shown as circular openings in the example shown in FIG. 3, the openings 312 can have additional, and/or varying, size, shapes and/or arrangements. The end caps 310a, 310b can assist with retaining the filter media 330 within the filter cartridge. In an embodiment, the openings 312 can be sized, shaped and/or arranged to assist with retaining the filter media 330 within the filter cartridge 300.

The filter cartridge 300 can also include permeable membranes 320a, 320b that can be affixed, or retained, to the filter cartridge 300 to assist with retaining the filter media 300 within the filter cartridge 300. The permeability of the membranes 320a, 320b allows water to flow through the membrane and into the filter media 300. The membranes 320a, 320b can be retained to the filter cartridge 300 in a permanent, semi-permanent, or releasable manner. In an example embodiment, the membranes 320a, 320b can be retained to the filter cartridge 300 using an adhesive to adhere, or heat to fuse, the membranes 320a, 320b to the main body 302 of the filter cartridge 300. In another example, the membranes 320a, 320b can be retained to the main body 302 by one or more mechanical fasteners, such as retaining rings, straps, and/or clamps. In a further example, the membranes 320a, 320b can be retained to the main body 302 by placing, or sandwiching, a periphery of the membranes 320a, 320b between the inner surface of the main body 302 and the outer surface of an insert. The insert can be profiled and/or sized to fit snugly, or securely, to the interior surface of the main body 302 and the membranes 320a, 320b to hold the membranes 320a, 320b in place with a frictional fit. Alternatively, or additionally, mechanical, or other, fastening means, such as bolts, rivets, and/or adhesive, can be used to secure the insert to the main body 302.

The membranes 320a, 320b can be constructed of a material that allows for the flow of fluid through the membranes 320a, 320b and/or substantially prevents the passage of filter media through the membranes 320a, 320b. In an example, the membranes 320a, 320b can be constructed of a fabric and/or screen material, such as a geotextile. The fabric and/or screen material can be a woven material that allows for the permeation and/or flow of fluid through the material while preventing solid material, such as the filter media 330, from passing through. In another example, the membrane 320a, 320b can be a perforated material, such as a perforated metal, plastic, composite or other material. Fluid can flow, or permeate, through the perforations of the material while preventing the passage of the filter media 330. The material, and/or treatment of the material, of the membranes 320a, 320b can be selected based on one or more factors, such as the a required, or desired, level of flow/permeation through the membranes 320a, 320b, the particle size of the filter media 330 and/or other factors/considerations.

In an example embodiment, the filter cartridge 300 can include the end caps 310a, 310b to retain the filter media 330 within the filter cartridge 300 without the inclusion of the permeable membranes 320a, 320b. In another example, the filter cartridge 300 can include the permeable membranes 320a, 320b to retain the filter media 330 within the filter cartridge 300 without the inclusion of the end caps 310a, 310b. In this embodiment, multiple filter cartridges 300 can be connected together to for the series of filter cartridges 300 by connecting the ends of the main bodies 302 of the filter cartridges 300. In a further example, the filter cartridge 300 can include both the end caps 310a, 310b and the permeable membranes 320a, 320b, with one or both assisting with retaining the filter media 330 within the filter cartridge 300. In yet another example, the end caps 310a, 310b can be for protective purposes and can be removed prior to installation of the filter cartridge 300 within a well. Further, the end caps 310a, 310b and the permeable membranes 320a, 320b can be a single unit that can be attached, affixed and/or fastened to the main body 302 of the filter cartridge 300 to assist with retaining the filter media 330 therein.

The filter media 330 filters/treats contaminated water as the water permeates and/or flows through the filter media 330. Contaminants within the water can be captured or broken down by the filter media 330, or portions thereof, such as by a chemical, mechanical and/or other process, or interaction, between the contaminants and the filter media 330.

The filter media can include one or more components and/or materials, such as a filler material and/or a filtering, or contaminant removal, material. The filtering material and the filler material can be combined, or mixed, to form the filter media 330 to be placed in the filter cartridge 300. In an example, the filter media 330 can include a reactive filtering material, such as zero valent iron, and a filler material, such as sand, polymer beads, organic materials and/or other suitable filler materials. The filler material can be selected based on one or more parameters, such as a packing density of the filler material, a composition of the filler material, a reactivity of the filler material to the expected contaminant(s), and/or other factors/considerations. Contaminants, such as chemical contaminants, in the contaminated water will contact the filtering material, such as zero valent iron, as the contaminated water filters, or permeates, through the filter media 330. Contact of the contaminants and the filtering material can cause the two to react and reduce, or breakdown, the contaminant to another compound and/or can cause the two to bind together which can trap the contaminant to the filtering material. In the example of bonding between the contaminant and filtering material, the filter cartridge 300 and/or filtering material can be later removed for treatment and/or disposal, or left in place contained within the filter cartridge 300.

In an example, the filter media 330 can be a dry material, such as a powder, that can be mixed, or prepared, and placed/packed into the main body 302 of the filter cartridge 300. Various ratios of the filler and filtering materials can be used to form the filter media 330 and the ratio can be selected based on one or more parameters, such as a desired weight per volume of the filter material 330, one or more of the filler material and filter material properties/characteristics, the contaminant to be filtered, an expected flow rate of water through the filter cartridge 300, and/or other design, use and/or environmental considerations. In another example, the components of the filter media 330 can be placed/packed into the main body 302 in layers, such as alternating layers of filtering material and filler material, or other arrangements.

The filter media 330 can also be placed/packed into the main body 302 of the filter cartridge as a moist or wet material. The moist and/or wet filter media 330 can assist with mixing the filler and filtering materials, the two materials can be mixed within a liquid to assist with distributing the filler and filtering materials within the filter media 330, and/or with packing the filter media within the main body 302. For example, the filter media 330 can be mixed with a liquid, such as water, to form a slurry that can then be placed or pumped into the main body 302. The fluid weight of the moist/wet filter media 330 can assist with packing the filter media 330 completely within the main body to prevent voids or pockets within the filter media 330. The liquid portion can then be removed, optionally, such as by draining and/or evaporation. Various fluids can be mixed with the filter material 330 and/or the fluid can act as a filler material for assisting with distributing the filter material within the main body 302.

The filter cartridge 300 can include an optional baffle 340 that can be placed in the filter media 330. The baffle 340 can be positioned within the filter media 330 to assist with directing the flow, or permeation, of contaminated water through the filter media 330. As fluid, such as contaminated water, flows through the filter media 330 it can create channels or voids due to erosion and/or movement of the filter media 330. Contaminated water can then flow through these channels or voids rather than permeating through the filter media. Additionally, the filter media 330 may settle creating a gap between the interior surface of the main body 302 and the surface of the filter media 330. Contaminated water can flow through this space rather than permeating through the filter media 330 where it would be filtered. The baffle 340 can seal against the inner surface of the main body, such as by a flange or applied sealant, to prevent the flow of fluid, such as contaminated water, between the inner surface of the main body 302 and the exterior of the baffle 340. Fluid contacting the face of the baffle 340 is required to flow towards the interior of the filter media 330 before passing through the baffle 340. In this manner, fluid flowing, or permeating, through the filter media 330 is directed inward upon contacting the baffle 340. This can prevent fluid from bypassing the filter media 330 by flowing between the interior surface of the main body 302 and a surface of the filter media 330. Additionally, the baffle 340 can intersect channels forming in the filter media 330 and prevent the channels from extending past the baffle 340. While a single, ring-shaped baffle 340 is shown in FIG. 3, additional baffles 340 can be included within the filter media 330 and can have a variety of profiles, shapes and/or openings to allow fluid to permeate, or flow, through the baffle 340. For example, the baffle can be a plate that includes openings arranged thereon to allow the flow, or permeation, of fluid through the baffle.

A filter cartridge, such as 300 of FIG. 3, can be constructed at, or near, the site where it will be installed and/or used, or the filter cartridge can be constructed at a location and transported to the site for use and/or installation. The modular, or unit, construction of the filter cartridge can allow it to be assembled in a variety of conditions and allow for various test and checks, such as quality control, to be performed prior to installation of the filter cartridge. In an example, the filter cartridge can be constructed at a facility under controlled condition and/or with the use of one or more devices/systems, to assist with the required, or desired, parameters of construction the filter cartridge. This can assist with the proper preparation and/or packing of the filter media, such as the distribution of filter and filler material within the filter media and/or the proper packing of the filter media to reduce the potential for settling and/or channeling of the filter media during use.

In an example, a filter cartridge can be constructed by affixing an optional end cap and/or permeable membrane to a first end of a main body. Filter media can be prepared by mixing the filler and filter material to a ratio and/or distribution. The filter media can then be placed, or packed, into the main body from a second end and against the end cap and/or 16 710364.000903 permeable membrane affixed to the first end. Various techniques, devices and/or systems can assist with placing, or packing, the filter media within the main body. For example, a vibrator or compactor can be used to pack the filter media within the main body. The main body can be, optionally, filled partially with filter media and a baffle can be placed within and, optionally, sealed to the interior surface of the main body. Packing of the main body with filter media can then resume until the main body is filled with a required, or desired, amount or level of filter media. Once filled, another end cap and/or permeable membrane can be affixed to the second end of the main body to complete the filter cartridge. The filter media of the filter cartridge is contained by the main body and end caps/permeable membranes of the filter cartridge.

During construction, or manufacture, of the filter cartridge, sensors, devices and/or systems can be optionally placed within the filter cartridge. In an example, a point velocity probe can be placed within the filter cartridge, such as within the filter media, during construction of the filter cartridge. The point velocity probe can measure data regarding the flow of fluid, such as contaminated groundwater, through the filter cartridge and can provide that data to an external device, system and/or user by a wired and/or a wireless connection. Various other sensors, device and/or systems can be placed in, or integrated with, the filter cartridge during construction. These sensors, devices and/or systems can assist with monitoring the performance of the filter cartridge and/or series of filter cartridges to which the sensor, device and/or system containing filter cartridge is connected to. In another example, the filter media of a filter cartridge can be absent and/or composed of only a filler material to form a monitoring pod that can be installed within a well or bore to monitor one or more conditions, such as groundwater flow. The sensor, device and/or system containing filter cartridges can be connected as needed, or desired, within a series of connected filter cartridges and/or installed as a single unit within a well or bore.

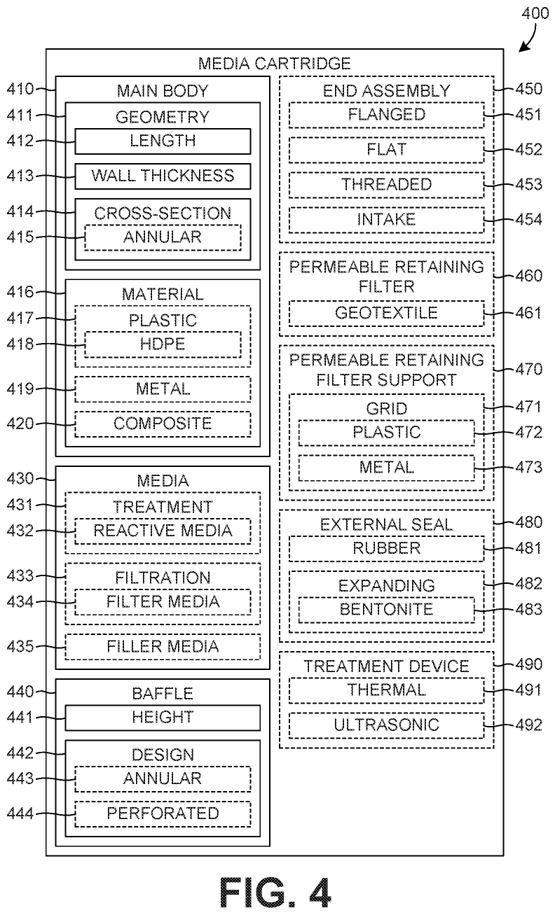

FIG. 4 is a block diagram of an example media/filter cartridge 400. The media cartridge 400 includes a main body 410, media 430, a baffle 440, and optionally, an end assembly 450, a permeable retaining filter 460, a permeable retaining filter support 470, an external seal 480, and/or a treatment device 490. Fluid, such as contaminated groundwater, enters the media cartridge 400 and permeates through the media 430 contained therein. The media 430 interacts physically and/or chemically with one or more contaminants of the fluid to remove/breakdown the one or more contaminants from the permeating fluid. The fluid then exits the media cartridge 400 and can flow into another media cartridge, the surrounding environment, a holding location and/or another device, location, system and/or environment. Multiple media cartridges 400 can be interconnected to assist with remediating the contaminated fluid, such as groundwater, and/or the environment about the media cartridges 400.

The main body 410 of the media cartridge 400 has a geometry 411, including a length 412, a wall thickness 413 and a cross-section 415. The main body 410 has a hollow geometry 411 to allow the media 430 to be placed/positioned therein. The main body 410 has a first end and a second end that are spaced apart by the length 412. The length 412 can be dependent on various factors, such as the media 430 to be placed therein, an environment in which the media cartridge 400 will be placed, a flow rate through the media cartridge 400 and/or other factors. In an example, the main body 410 can be a pipe having an annular cross-section 415 and a wall thickness 413. The wall thickness 413 can be based on the structural properties of a material 416 of main body 410, the length 412 and/or cross-section 414 of the main body 410, the environment in which the media cartridge 400 will be placed, durability/longevity of the media cartridge 400 and/or other factors/forces the media cartridge 400 will be subjected to, such as during use, transport and/or installation. The cross-section 414 of the main body 410 can one of a variety, such as a square/rectangular cross-section, a circular cross-section and/or other hollow body cross-sections. The cross-section 414 can be selected based on a one or more factors, such as manufacturing, transporting, installation and/or use considerations.

The material 416 of the main body 410 can be a plastic 417, such as high-density polyethylene (HDPE) 418, metal 419 and/or a composite material 420. The material 416 can be selected based on one or more factors, such as manufacturing, transporting, installation and/or use considerations. An example metal material 419 can include iron or steel, such as iron or steel pipes. An example composite material 420 can include reinforced concrete, fiberglass, carbon fiber and/or other composite materials, such as fibrous or mat materials, that can be formed into the hollow body structure of the main body 410. In an example embodiment, the main body 410 can be made of HDPE 418, which can provide the requisite strength/rigidity needed for manufacturing, installation and/or use of the media cartridge 400. Another consideration for selecting a material 416 can be reactivity with potential contaminants within the environment in which the media cartridge 400 will be placed and/or contaminants in the fluid the media cartridge 400 will treat. Certain materials 416 can have accelerated degradation of one or more material properties, such as strength, and/or longevity of the material, when exposed to certain contaminants. Additionally, certain materials 416 can react with contaminants to create additional and/or more harmful contaminants. The material 416 of the main body 410 can be selected to avoid such accelerated degradation and additional contaminant creation.

The media 430 is placed/packed within the main body 410 of the media cartridge. The media 430 can be composed of discrete pieces/elements having substantially the same size or a variety of sizes. In examples, the media 430 can be a powder-like, granular, pellet or formed material that is porous and/or permeable to a fluid, such as contaminated groundwater. The media 430 can be placed and/or packed within the main body 410 to have a density and/or arrangement to allow the fluid to permeate through the media 410. In an embodiment, the media 430 can be mixed with fluid to form a slurry to assist with placing the media 430 within the main body 410.

The media 430 can be composed of one or more parts, such as a treatment media 431, a filtration media 433 and/or a filler media 435. The ratio of the various constituents of the media 430 can be based on various factors, such as desired flow/permeation rate through the media 430, the manufacturing/processing of the media 430, the working lifespan of the media cartridge, the contaminants expected to be filtered/treated by the media cartridge and/or other considerations. In an example, the treatment media 431 can be small in size, such as powdery or granular, that would have little permeation/flow there through when placed into the main body 410. To achieve the needed/desired permeation through the media 430, the treatment media 431 can be mixed with a filler media 435 that is of larger/varying size to that when the combination of filler 435 and treatment media 431 is placed within the main body, there are permeation pathways through the media 430 to allow fluid to move through. The distribution of the treatment media 431 within the media 430 can be such to have a high probability that the majority of the fluid permeating through the media cartridge 400 will encounter/contact the treatment media 431 at some point during the transition of the fluid through the media cartridge 400.

The treatment media 431 can treat chemical, biological and/or other contaminants within a fluid, such as contaminated groundwater. To treat the contaminants, the treatment media 431 can interact with the contaminants, such as chemically react with the contaminants, to remove, reduce and/or otherwise assist with removing the contaminant(s) from the fluid. In an example, the treatment media can be a reactive media 432, such as zero valent iron, that reacts with contaminants to chemically reduce the contaminants to another form/compounds. In another example, the treatment media 431 can be a catalyst that accelerates a reaction that removes, reduces, and/or otherwise interacts with/changes contaminants within the fluid, such as aggregating/agglomerating the contaminants or change the contaminants to another form/compound. In a further example, the treatment media 431 can chemically bind to the contaminants to assist with removing the contaminants from the fluid, such as by forming a more easily removed/filtered molecule/compound, or chemically bind to the contaminants to form a less polluting/harmful molecule/compound.

The filtration media 433 can include filter media 434 that physically removes/captures contaminants from a fluid, such as contaminated groundwater. The filter media 434 can be a porous/permeable material, such as a powder, granular material, pellets and/or other material that can physically capture one or more contaminants. Example filter media 434 can include sand, clay, plastic pellets and/or other media that physically removes/captures a contaminant. Additionally, the filter media 434 can be media that supports growth of one or more biological organisms to assist with treating/filtering the contaminated fluid. For example, the filter media 434 can have a surface or profile to assist/encourage growth of bacteria that can assist with treating/remediating the contaminated fluid.

The filler media 435 can be a bulking media that can be mixed with one or more of the treatment 431 and/or filtration media 433 to achieve the desired/required properties of the media 430, such as a density, porosity/permeability, cost, weight, manufacturing and/or other considerations. The filler media 435 can be non-reactive with the contaminants and can have one or more properties to assist with evenly distributing the treatment and/or filtration media 431, 433 within the filler media 435.

The baffle 440 is positioned within the media 430 within the main body 410 of the media cartridge 400. The baffle has a periphery that contacts the interior circumference/surface of the main body 410 and can be press-fit into the main body and/or can be adhered/affixed to the interior surface of the main body, such as by welding, bonding and/or an adhesive. The baffle has a design 442, having one or more openings to allow fluid to flow/permeate pass the baffle 440 within the main body 410. Example baffle designs 442, can include an annular design 443 or a perforated design 444. The annular design 443 has a centrally positioned opening to allow the fluid to flow through the baffle 440 and the perforated design 444 includes multiple openings disposed on/through the baffle 440 to allow the fluid to flow through the baffle 440. The opening(s) of the baffle 440 is positioned a distance interior an outer circumference of the baffle 440, such that the opening(s) are positioned a distance away from the interior surface of the main body 410 when the baffle 440 is placed therein. This spacing distance is the height 441 of the baffle 440, an area between the periphery of the baffle 440 and the opening(s) of the baffle 440. By having a height 441 around the baffle 440, fluid contacting the baffle is forced to flow towards the interior of the media cartridge 400. By forcing the fluid to change direction, the fluid can be prevented from forming channels through the media 430, which are more likely to occur along the interior surface of the main body 410. If channels are formed through the media 430, the fluid is more likely to flow through the channels rather than permeate through the media 430, which can cause at least a portion of the fluid to flow through the media cartridge 400 untreated. The baffle 440 within the main body 410 assists in preventing the formation of channels within the media 430 and with preventing fluid to flow through the media cartridge 400 untreated.

An optional end assembly 450, or end cap, can be disposed at one or both ends of the main body 410. The end assembly 450 can assist with interconnecting multiple media cartridges 400, assist with placing the media cartridge 400 and/or receiving/directing fluid into the media cartridge 400. The end assembly 450 can be coupled to/integrated with the main body 410, such as by welding, fusing, adhering and/or otherwise coupling/connecting the end assembly 450 to the main body 410. Alternatively, the main body 410 can include a portion, or elements, of the end assembly 450, such as by molding or forming the main body 410 to form the portion/elements of the end assembly 450. Alternatively, the end assembly 450 can be releasably coupled/connected to the main body 410 of the media cartridge 400, such as by adhesive, removable fasteners, a threaded connection and/or other releasable connection/coupling.

A flanged end assembly 451 can include a flange having one or more openings disposed thereon, such as about a periphery of the flange and a central opening through which fluid can flow into/from the media cartridge 400. A fastener, such as a bolt, can be passed through both one of the openings of the flanged end assembly 451 of the media cartridge 400 and then through an opening of another flanged end assembly of another media cartridge and secured, such as by a nut, to restrain/couple the media cartridge 400 to the other media cartridge. Other fasteners, such as screws, pins and/or other fasteners/fastening systems can be used to secure the flanged end assembly 451 of the media cartridge 400 to another flanged end assembly of another media cartridge. Additionally, the flanged end assembly 451 can include a gasket or seal that is compressed when two media cartridges are coupled to assist with maintaining a substantially impermeable seal between the two cartridges to prevent the fluid exiting one media cartridge from flowing into the surrounding environment rather than into the coupled/connected media cartridge.

A flat end assembly 452 of the media cartridge 400 can be mated/joined to, or abutted with, a flat end assembly of another media cartridge. To interconnect two media cartridges, the flat end assembly 452 can be welded, fused, adhered or otherwise coupled to a flat end assembly of another media cartridge. The flat end assembly 452 can include one or more openings to allow fluid to pass into/from the media cartridge 400.

A threaded end assembly 453 can include threads to allow the end assembly 453 to connect to another threaded element, such as a threaded end assembly of another media cartridge. To interconnect media cartridges having threaded end assemblies 452, the media cartridges can be screwed together. Alternatively, or additionally, the threaded end assembly 452 can allow another threaded element to connect to the media cartridge, such as a drill rod. The end of the drill rod can be threaded and can be screwed to the threaded end assembly 452 of the media cartridge 400 to releasably connect the two. The connected drill rod can be used to move/push the media cartridge into, or extract from, a position, such as in a well.

An intake end assembly 454 can have opening and/or be permeable to allow fluid to flow from the surrounding environment into the media cartridge 400. In a series of interconnected media cartridges, a media cartridge at an end of the series can include the intake end assembly 454 to allow fluid, such as contaminated groundwater, to enter the series of media cartridges for treatment/remediation.

The permeable retaining filter 460 can be a permeable barrier that allows fluid to pass/permeate through and that is placed within the main body 410 to retain the media 430 therein. The permeable retaining filter 460 can be a rigid or flexible material that is structured/sized to prevent the media 430 from substantially flowing past/through the filter 460, while allowing fluid, such as contaminated groundwater, to pass/permeate there through. In an example, the permeable retaining filter 460 can be made of a geotextile 461 that allows the fluid to pass/permeate through. In the example, the permeable retaining filter 460 is flexible and can be reinforced by a permeable retaining filter support 470 that can be places against and/or coupled to the permeable retaining filter 460 to assist with maintaining its placement within the main body 470. In an example, the permeable retaining filter support 470 can be a grid 471, made of plastic 472, metal 473 or another material, that assists with retaining the permeable retaining filter 460 within the main body 410 and/or against the media 430.

An external seal 480 can be disposed about the outer periphery/circumference of the media cartridge 400 to prevent fluid from flowing around the exterior of the media cartridge 400. The external seal 480 can extend from the outer surface of the media cartridge 400 to contact the surrounding environment to form a substantially impermeable barrier to prevent fluid from flowing around rather than through the media cartridge 400. In an example, the external seal 480 can include a rubber seal 481 and/or an expanding seal 482. The rubber seal 481 can compress against the outer surface/periphery/circumference of the media cartridge 400 and the surrounding environment, such as the interior of a well/well casing, to prevent the flow of fluid past/around the media cartridge 400. The expanding seal 482 can be disposed/placed around the exterior surface/circumference of the media cartridge 400 and can expand, such as by hydration or inflation, to compress against the exterior surface and the surrounding environment. In an example, the expanding seal 482 can include, or be composed of, bentonite 483 which expands in volume in the presence of water, such as contaminated groundwater within the surrounding environment.

The media cartridge 400 can optionally include a treatment device 490, such as a thermal 491 or ultrasonic treatment device 492. The treatment device 490 can be a powered device that assists with breaking down, reducing, or killing contamination within the fluid as it passes through the media cartridge 400. The fluid passing through the media cartridge 400 can contact or be effected by the treatment device 490 to treat/remediate the fluid. In an example, the thermal treatment device 491 can raise a temperature of the fluid, such as contaminated groundwater, to assist with treating the fluid, such as by killing biological organisms, accelerating/catalyzing a chemical reaction, break down a compound/molecule and/or other treatment of the fluid. In another example, the ultrasonic treatment device 492 can subject the fluid to ultrasonic energy which can assist with treating the water, such as by interrupting biological processes of biological contaminants, assist with breaking down/reducing contaminants and/or assist with moving the fluid through the media cartridge 400.

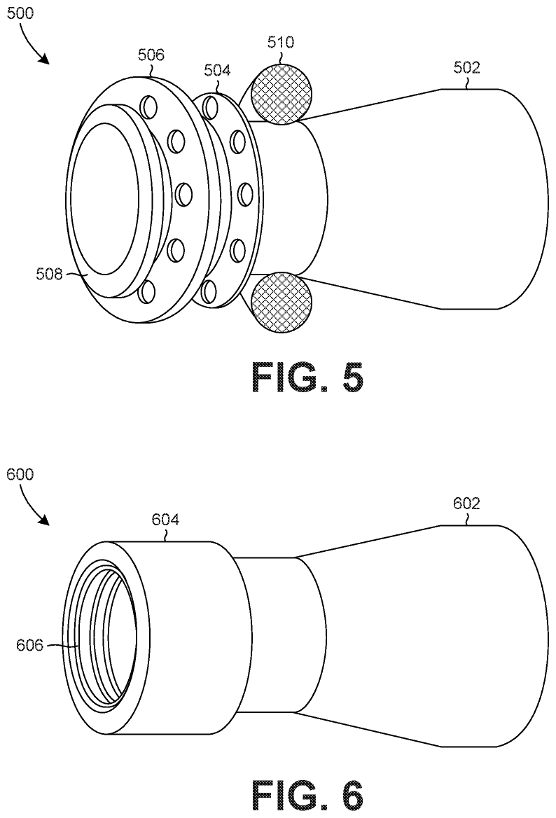

FIG. 5 is an example flanged end assembly 500 that includes a reducer 502, a flange connecting plate 504, rubber seal 506 and a flange 508. The flanged end assembly 500 can be connected to other flanged end assemblies by passing a fastener through an opening of the connecting plate 504 and rubber seal 506 and through similar openings of another flanged end assembly. The fastener can be tightened to compress the flange 508 and rubber seal 506 of the two flanged end assemblies together to form a seal/connection therebetween. Fluid, such as contaminated groundwater can pass through an opening of the flanged end assembly 500 of a first media cartridge and into an opening of another flanged end assembly of another connected media cartridge. The rubber seal 506 can assist with connecting/sealing two media cartridges together and/or can form an external seal to prevent fluid from flowing past/around the connected media cartridge of the flanged end assembly 500. Also shown in FIG. 5 is an expanding seal 510 that can expand, such as in the presence of groundwater, to form a seal between the exterior surface of the media cartridge—the exterior surface of the reducer 502 in the figure shown, and the surrounding environment.

FIG. 6 is an example threaded end assembly 600 that includes a reducer 602 and a threaded portion 604 having interior threads 606. The threaded portion 604 can receive a threaded element, such as a complimentary threaded end assembly of another media cartridge or a drill rod, to connect the threaded end assembly 600 of the media cartridge to another element. In the example shown, a threaded drill rod can connect to the threaded end assembly 600 to connect the media cartridge to the drill rod. The drill rod can then be manipulated to insert or extract the media cartridge from a position, such as within a drilled well. Alternatively, or additionally, another end assembly can include a threaded portion having threads about its exterior to allow it to interface/connect to the threaded portion 604 of the threaded end assembly 600 to interconnect two media cartridges.

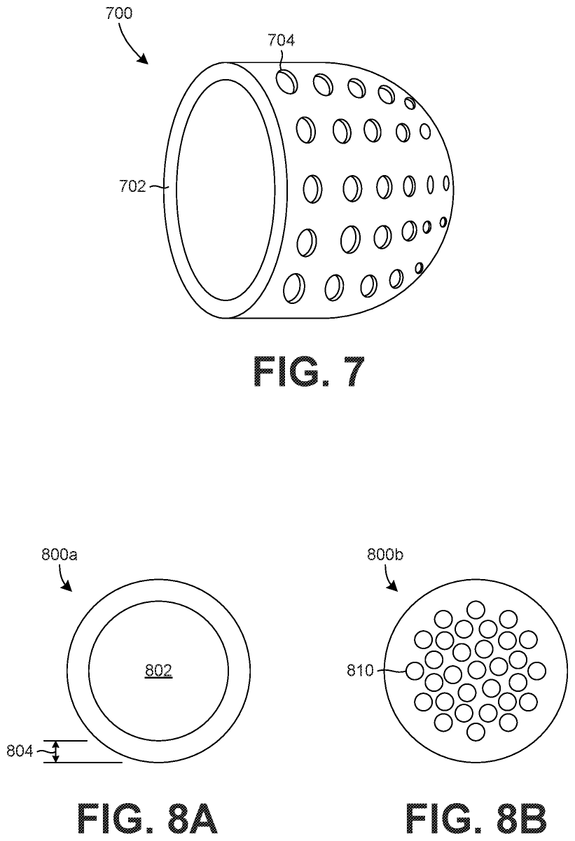

FIG. 7 is an example intake or exit end assembly 700 having an end 702 and a plurality of openings 704 disposed thereon. The openings 704 allow fluid, such as contaminated groundwater, to pass through the intake end assembly 700 and into the connected media cartridge. The media cartridge can be connected to the intake end assembly 700 by coupling the end 702 to an end of the main body of the media cartridge. The end assemblies of FIGS. 5 and 6 can be similarly connected/coupled to the main body of the media cartridge. Alternatively, the end assemblies of the media cartridge, such as those of FIGS. 5-7, or portions thereof, can be integrated/formed with the main body of the media cartridge.

FIGS. 8A-8B illustrate example baffles 800a and 800b of a media cartridge. The baffle 800a is annular with a central opening 802 and a height 804. The central opening 802 allows fluid to pass/permeate through the baffle 800a and the height 804 redirects peripheral fluid flow through the media cartridge towards the center of the media cartridge. This redirection of fluid flow can assist with preventing channels from forming in media contained within the media cartridge. Similarly, the baffle 800b include multiple openings 810 that are spaced away from the periphery of the baffle 800b to redirect fluid flow contacting the periphery of the baffle 800b. Again, the redirection of the fluid flow can assist with preventing channel formation within/through media contained within the media cartridge.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be used for realizing the invention in diverse forms thereof.

1. A media cartridge, comprising:
a main body having an interior surface and exterior surface and having a first end and a second;
a media, the media contained within the main body and structured to at least one of filter or treat a fluid permeating through the media; and
a baffle, the baffle disposed within the media, a periphery of the baffle contacting the interior surface of the main body and the baffle having one or more openings spaced away from the periphery of the baffle.

2. The media cartridge of claim 1, further comprising an end assembly coupled to the main body of the media cartridge, the end assembly configured to at least one of restrain the media within the cartridge, provide an interconnection between another media cartridge and provide a connection to a drill rod assembly.

3. The media cartridge of claim 2, wherein the coupling between the end assembly and the main body is one of a fused connection, a welded connection or a mechanical fastener connection.

4. The media cartridge of claim 1, wherein the end assembly includes a flange having one or more openings disposed thereon to allow the flange of the media cartridge to be coupled to another flange of another media cartridge by a fastener passing through one of the one or more openings of the flange and an opening of the another flange.

5. The media cartridge of claim 2, wherein the end assembly includes a threaded opening structured to be couplable to a drill rod.

6. The media cartridge of claim 1, wherein the end assembly is a porous structure configured to allow a fluid to pass through the end assembly and into the main body.

7. The media cartridge of claim 1, further comprising a first and a second permeable retaining filter, the first and second permeable retaining filters positioned within the main body to retain the media within the main body.

8. The media cartridge of claim 7, wherein the first and second permeable retaining filters are composed of a flexible material and further comprising a first and a second permeable retaining filter support configured to restrain the permeable retaining filter within the main body.

9. The media cartridge of claim 7, wherein the first and second permeable retaining filters are constructed of a geotextile.

10. The media cartridge of claim 1, wherein the media includes a reactive media configured to react with one or more contaminants within a fluid permeating through the media cartridge, the reacting causing the one or more contaminants to be chemically reduced.

11. The media cartridge of claim 1, wherein the media include a filtration media composed of a plurality of media elements configured to retain at least a physical contaminant of a fluid permeating through the media cartridge.

12. The media cartridge of claim 1, wherein the baffle is coupled to the interior surface of the main body.

13. The media cartridge of claim 1, further comprising a circumferential seal disposed about a circumference of an exterior surface of the main body, the circumferential seal configured to contact a surrounding environment of the media cartridge to minimize a fluid passing around the main body of the media cartridge.

14. The media cartridge of claim 13, wherein the circumferential seal is a flexible seal.

15. The media cartridge of claim 14, wherein the flexible seal is a rubber seal disposed about the circumference of an exterior surface of the main body and sized to extend from the exterior surface of the main body to the surrounding environment of the main body.

16. The media cartridge of claim 13, wherein the circumferential seal is an expanding seal configured to expand from a first circumference to a second circumference in the presence of water.

17. The media cartridge of claim 16, wherein the expanding seal includes bentonite contained within a permeable material and disposed about the circumference of the exterior surface of the main body.

18. A groundwater treatment cartridge, comprising:
a main body having an annular cross-section with an interior surface and an exterior surface of the main body, and a first end and a second end of the main body;
a media contained within the main body, the media at least one of filtering or treating groundwater as the groundwater permeates through the media;
an annular baffle disposed within the main body and positioned within the media contained within the main body, the annular baffle having an outer circumference that contacts the interior surface of the main body and one or more openings spaced away from the outer circumference of the annular baffle;
a permeable retaining filter positioned within the main body and contacting the media, the permeable retaining filter configured to retain the media within the main body;
a first end assembly disposed at the first end of the main body; and
a second end assembly disposed at the second end of the main body.

19. The groundwater treatment cartridge of claim 18, wherein the media includes a reactive media to chemically reduce a contaminant within the groundwater that permeates through the groundwater treatment cartridge.

20. The groundwater treatment cartridge of claim 18, wherein at least one of the first end assembly or the second end assembly is flanged end assembly configured to couple the groundwater treatment cartridge to another groundwater treatment cartridge.
